(19) United States
(12) Patent Application Publication
(10) Pub. No.: US 2015/0169940 A1
(43) Pub. Date: Jun. 18, 2015

(54) METHOD FOR FACE MODEL ALIGNMENT ON UNSEEN FACES

(71) Applicant: CATHOLIC UNIVERSITY INDUSTRY ACADEMIC COOPERATION FOUNDATION, Seoul (KR)

(72) Inventors: Hang-Bong KANG, Seoul (KR); Myung-Ho JU, Gyeonggi-do (KR)

(73) Assignee: CATHOLIC UNIVERSITY INDUSTRY ACADEMIC COOPERATION FOUNDATION, Seoul (KR)

(21) Appl. No.: 14/207,085

(22) Filed: Mar. 12, 2014

(30) Foreign Application Priority Data
Dec. 18, 2013 (KR) 10 2013 0158195

(51) Int. Cl. G06K 9/00; G06T 11/00; G06T 7/00

(52) U.S. Cl. CPC G06K 9/00268; G06T 7/0024; G06T 11/001

(57) ABSTRACT

The method of face model alignment on unseen face includes inputting a face image; warping the face image into a standard shaped face based on a model seen by AAM (Active Appearance Model); normalizing the warped image by removing a texture change of the warped image; extracting a face texture from the normalized image; calculating error areas by comparing the face texture with the seen model; and aligning edges of the face texture with edges of the seen model while reducing the difference of the error areas.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a method for face model alignment on unseen faces and in particular a method of face model alignment on unseen faces to align the texture and the shape of the input faces with the normalized face area model by using land marks of the input faces for the calculation of error.

2. Description of Related Art Including Information Disclosed Under 37 CFR 1.97 and 37 CFR 1.98.

With The technique to recognize an individual by an image of the photographed person is being used in many applications. In one example, this technique is used when access control is needed and the features of a face are used to control access instead of a key or an access card. Also, the face alignment for the identification of a suspect in crime is used to trace and identify a face of an individual by finding main features or land marks of the face.

In this regard, Cootes (T. F. Cootes, G. V. Wheeler, K. N. Walker and C. J. Taylor. “View-based [0003] active appearance models”, Image and Vision Computing, vol. 20, pp. 657-664, 2002.) suggests View-based AAM method to make a face fitting by independently generating AAM (Active Appearance Model) on every pose of the face and by selecting AAM having minimum errors on the pose of the input face. However, this requires the seen images on every pose of the face and the correct face fitting is not ensured as the images are not seen or the difference of the seen pose and the pose of the input face increases.

Further, Chen and Wang (C.-W. Chen, and C.-C. Wang. “3D Active Appearance Model for Aligning Faces in 2DImages”, Proceedings of the IEEE/RS International Conference on Intelligent Robots and Systems, 3133-3139, 2008.) suggest a 3D AAM in which an AAM method and a stereo method are combined to estimate a 3D model of the face. This provides a 3D information of the input face by estimating information of the depth of a face using a stereo camera and by adding the depth information to the land marks of a face to see a 3D shape of the face using AAM method.

However, since people have different face color and shape, the face which is input as an image can be expressed with different textures and shapes. Also, the texture can be changed or distorted by the surroundings such as illumination, etc. and an occlusion by a certain object and a self-occlusion by a 3D face shape may prevent partially the representation of the face area in the image. The above problems are caused by various surroundings and make the face alignment for random faces difficult.

To solve the above problems, the present invention provides a method for face model alignment on unseen faces which ensures the face model alignment even when input images are photographed at various angles or input images are affected by the different face shapes or surroundings such as illumination, etc.

Further, by minimizing matching errors between the input face and the error model having the generalized face features, the present invention facilitates the easy alignment on the unseen faces.

### SUMMARY OF THE INVENTION

To achieve the object of the present invention, the present invention provides a method of face model alignment on unseen face comprising steps: (A) inputting a face image; (B) warping the face image which was input at the step (A) into a standard shaped face based on a model seen by AAM (Active Appearance Model); (C) normalizing the warped image by removing a texture change of the image warped at the step (B); (D) extracting a face texture from the image normalized at the step (C); (E) calculating error areas by comparing the face texture with the model seen at the step (B); and (F) aligning edges of the face texture with edges of the seen model while reducing the difference of the error areas.

In one preferred embodiment, the step (E) comprises: (E-1) calculating a texture error which is the difference of the texture of the seen model and the face texture extracted from the step (D); (E-2) calculating a shape error which is the difference of edges obtained from the texture of the seen model and edges of the face texture extracted from the step (D); and (E-3) calculating error areas by summing the texture error and the shape error.

In one preferred embodiment, in the step (E-2), the shape error is calculated at an extended area comprising some of pixels which are located outside of the edge corresponding to the boundary of the face area.

Further, the step (F) comprises a step of applying a generalized shape weight such that the edge area of the face texture corresponds to the edge of the seen model depending on the degree of how the edge of the face texture extracted from the step (D) is identical to the edge of the seen model.

Here, the generalized shape weight is provided in proportion to the distance difference between the edge of the face texture and the edge of the seen model.

According to the present invention, the efficient face alignment is ensured even when the change, distortion and occlusion of texture occur in the input image due to the influence of the surroundings such as the photographing at various angles, different face expressions, illumination, etc.

Further, since the generalized shape weight is used to perform the face alignment efficiently during the optimization of the face model, the good face alignment on random faces is guaranteed by the use of the face model seen on the face images.

Also, during the warping process, the generation of triangular mesh at the area extended to the surroundings of the face area facilitates the acquisition of the edge information.

### BRIEF DESCRIPTION OF THE DRAWINGS

FIG. 1 is a flow diagram of process to align face model according to the present invention.

FIG. 2 is a flow diagram of warping process according to the present invention.

FIG. 3 is a flow diagram of calculating an error area according to the present invention.

FIG. 4 shows an example of calculating error areas from an input image according to the present invention.

FIG. 5 shows an extraction of edges at extended area from an input image according to the present invention.

FIG. 6 shows examples of warping images and face shape information from input images.

FIG. 7 shows occurrence of face shape error by the face alignment process.

FIG. 8 shows process of generating generalized shape weight according to the present invention.

FIG. 9 shows an example of applying land marks to the prior art for the evaluation of the present invention.

### DETAILED DESCRIPTION OF THE DRAWINGS

Hereinafter, examples of the present invention will be described in detail referring to attached drawings.

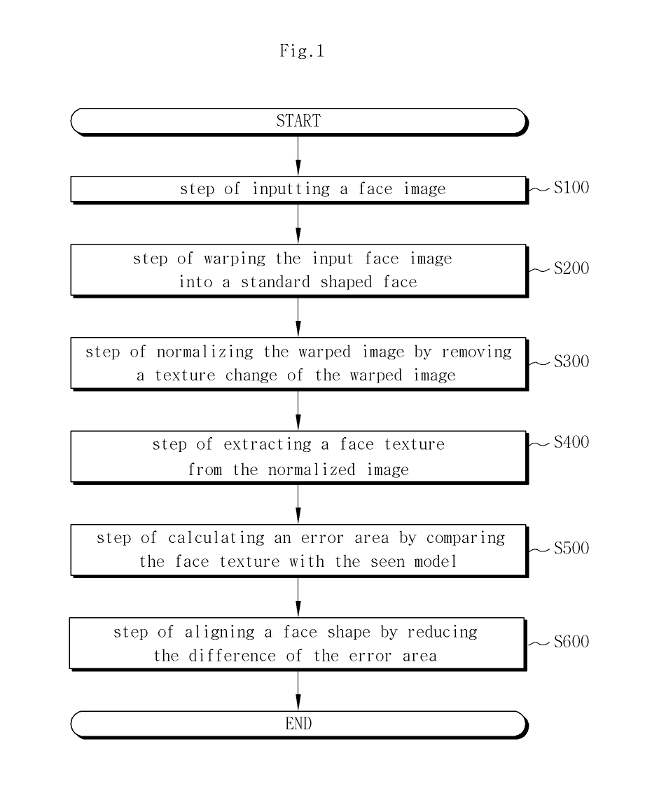

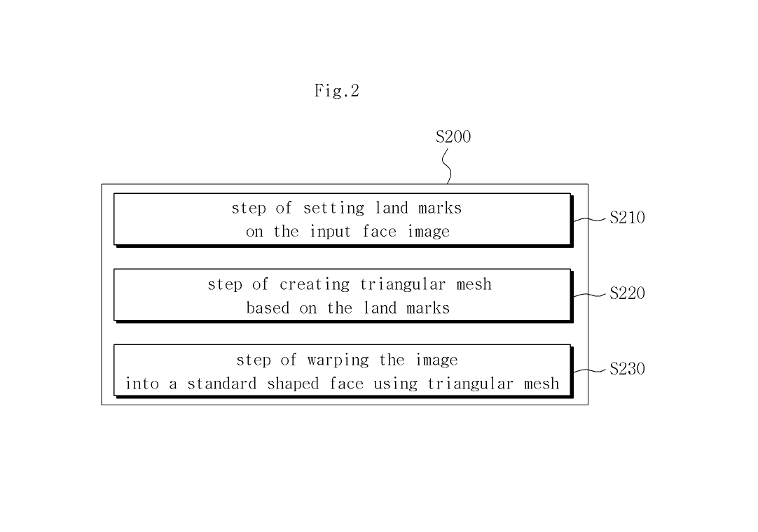

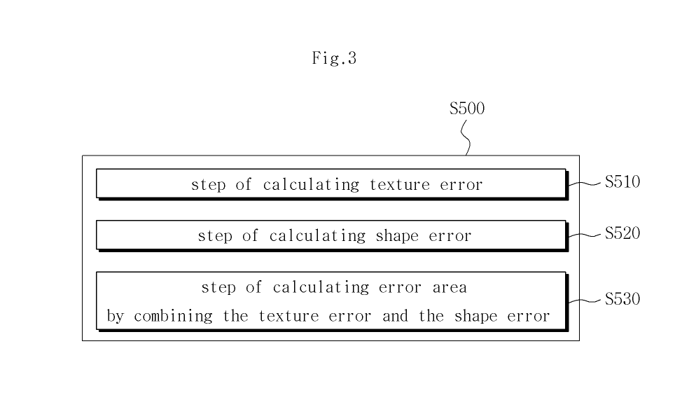

FIG. 1 is a flow diagram which shows process of face model alignment according to the present invention, FIG. 2 is a flow diagram of warping process according to the present invention, and FIG. 3 is a flow diagram of calculating an error area according to the present invention.

Referring to FIGS. 1 to 3, the method of aligning a face model on unseen face comprises: step of inputting a face image (S100); step of warping the input face image into a standard shaped face (S200); step of normalizing the warped image by removing a texture change of the warped image (S300); step of extracting a face texture from the normalized image (S400); step of calculating an error area by comparing the face texture with the seen model (S500); and step of aligning a face shape while reducing the difference of the error area (S600).

At the step of inputting a face image (S100), an image of a subject photographed by a lens is converted into an electrical signal and then is used as an input image, or an image having a face area is prepared from an image taken previously and then is used as an input image.

As can be seen in FIG. 2, the step of warping the input face image into a standard shaped face (S200) comprises: setting land marks (feature points) on the input face image (S210); creating triangular mesh based on the land marks (S220); and warping the image into a standard shaped face (S230).

The standardized face is a face obtained by aligning the face images to minimize the shape difference using Similarity Transformation and then by aligning face images such that respective elements of the faces have the same shape, size and direction.

In the present invention, a model is seen based on AAM (Active Appearance Model) to perform a face alignment and land marks of the face image are set to see the model.

In the step of setting land marks on an input face image (S210), to show effectively the position, size, protrusion, etc. of each part of the face, land marks are set on the edges such as side ends of the eye, side ends of the mouth, etc. Also, an edge area, such as the chin line, which is regarded as boundary is designated and land marks are set on the edge area.

In the step of creating triangular mesh based on the land marks (S220), a triangular mesh is created by the connection of the land marks. The created triangular mesh is expressed as edges of a body part which features the face, and then the step of warping an image of the input face into a standardized shape of the seen model (S230) is provided.

Warping transforms the texture of an image according to the shape of the image and matches pixel information in the triangle according to the distance between apexes of the triangular meshes.

Calculation of the difference of pixels of the faces is difficult since the texture of a face image has different pixels according to the shape or size of the face, and thus the input face image is warped into the standardized face shape. The face area can be expressed by the same number of pixels regardless of the face shape and the difference of pixels can be easily obtained.

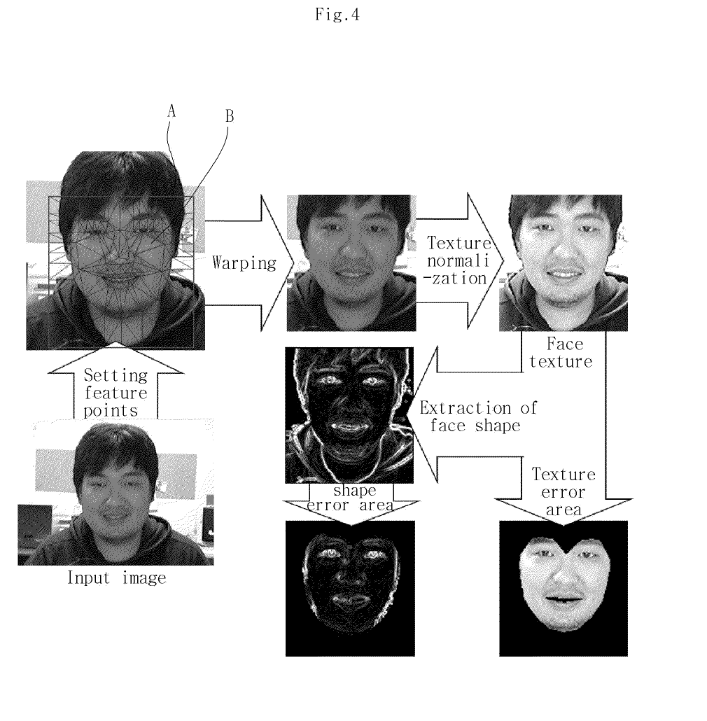

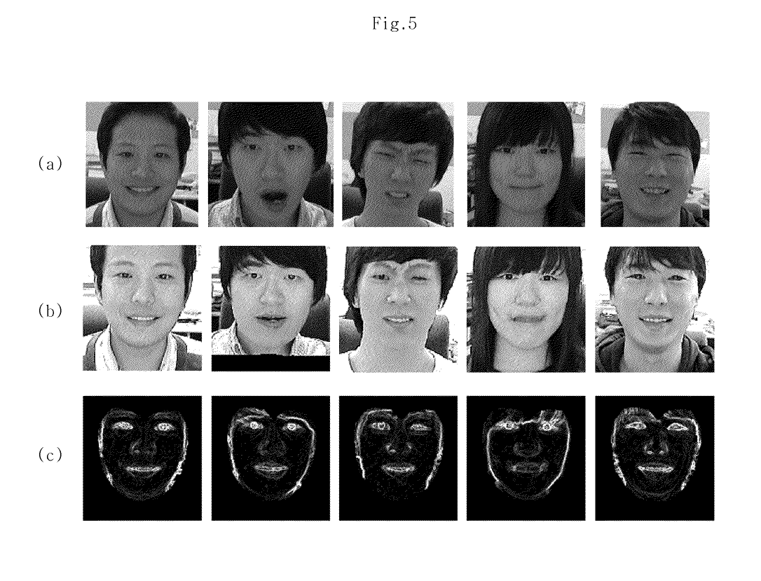

FIG. 4 shows a process of calculating error areas from an exemplary input image and FIG. 5 explains an extraction of edges at extended area in the input image according to the present invention. Referring to FIGS. 4 and 5, meshes of the present invention comprise the entire face area in the input face image and meshes are extended to the outside of the boundary of the face area. For example, as shown in ‘A’ in FIG. 4, a rectangular mesh is used to comprise the face area. As shown in FIG. 5, if meshes are created in the face area, edges of the face in the mesh do not show chin line clearly. However, if the meshes are extended to the outside of the boundary of the face area, the face shape is allowed to be expressed by edges and the area outside of the face such as a chin is allowed to be extracted, thereby information of all edges in the extended mesh area is available.

‘B’ in FIG. 4 shows that land marks are connected and a plurality of triangular meshes are used to represent an image area as a plane. The minimum unit to express a plane is a triangle and the use of triangular meshes minimizes the number of variables for the creation of mesh.

The step of normalizing the warped image by removing a texture change of the warped image (S300) comprises warping the face image into standard shaped face and photometric-normalizing, such as SSR (Single Scale Retinex), the warped face image to convert grayscale value expressed as pixel information of the image into the original value, thereby creating texture. If the change of texture caused by the illumination change in the photographic surroundings is removed, an image having normalized texture is obtained.

Then, the step of extracting a face texture in the normalized image (S400) follows. The area to be used for the face model alignment is a face area and thus the extracted face texture is used to extract a texture error and a shape error (appearance error) which will be described hereafter.

The step of calculating an error area by comparing the face texture with the seen model (S500) comprises step of calculating texture error (S510); step of calculating shape error (S520); and step of calculating error area by combining the texture error and the shape error (S530). The texture error is the difference between the texture of the seen model and the face texture obtained from warped image.

The shape error is the difference between edges of the model face and edges of the input face image. In an example of the present invention, edge information can be expressed in the texture and edge information is extracted from the texture information of the seen model.

Faces have different shape and thus if the shape error of the faces, i.e., the difference of edges, only is calculated, the calculated shape error is not effective for the face alignment. Therefore, to obtain shape information from the face, edge information of the face is extracted after warping of the input face into the standardized face is done, thereby the shape information of the different faces being normalized.

The face shape Fₛ is expressed below as formula 1 based on edge information which is represented by gradient of x axis and y axis.

Fₛ(x,y)=\sqrt{dx²+dy²} formula 1

Here,

dx=F(x+1,y)−F(x−1,y)

dy=F(x,y+1)−F(x,y−1)

Since the edge information obtained from formula 1 is extracted at the area which is extended inside and/or outside of the face edge, the face area is extended by k pixels to calculate the shape error. In one example, k is set to be 3, but the size to be extended can vary as necessity requires.

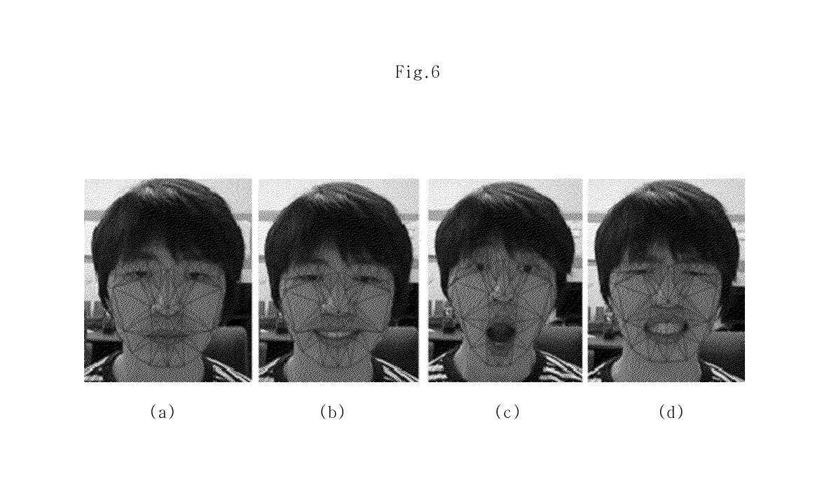

FIG. 6 shows examples of warped images and face shape information from the input images. Referring to FIG. 6, FIG. 6(a) shows face images of different shapes and textures and FIG. 6(b) shows images in which the texture normalization is applied to the input images and the input images are warped to have the average face shape. FIG. 6(c) shows edge images obtained through the texture normalization and the warping of the images into the average face shape, and shows that similar face shapes are obtained by normalization of the shape difference between the faces.

AAM defines an error model of formula 2 as shown below to minimize the difference of textures between the input face image and the model.

$$\sum {[ ( \overline{A} + {\sum }_{i = 1}^{m} {g}_{i} {A}_{i} ) - W ( I ; t ) ]}^{2} \qquad formula 2$$

Here, Ā is the average face texture, and gᵢ are Aᵢ a face texture space vector and a parameter of the model, respectively. W(·) is an warping function, I is an input image, and t is a transformation parameter such as size transformation, displacement transformation, etc.

Based on the error model of AAM, the error model of the present invention defines formula 3 below by the combination of the normalized texture error and the shape error.

$$\sum {[ ( \overline{A} + {\sum }_{i = 1}^{m} {g}_{i} {A}_{i} ) - N ( W ( I ; t ) ) ]}^{2} + w \sum {[ S ( \overline{A} + {\sum }_{i = 1}^{m} {g}_{i} {A}_{i} ) - S ( N ( W ( I ; t ) ) ) ]}^{2} \qquad formula 3$$

Here, N(·) is a texture normalization function, and S(·) is a edge extraction function using formula 3. W is a weight applied to the texture error and the shape error, and in this example, W is set to 1.

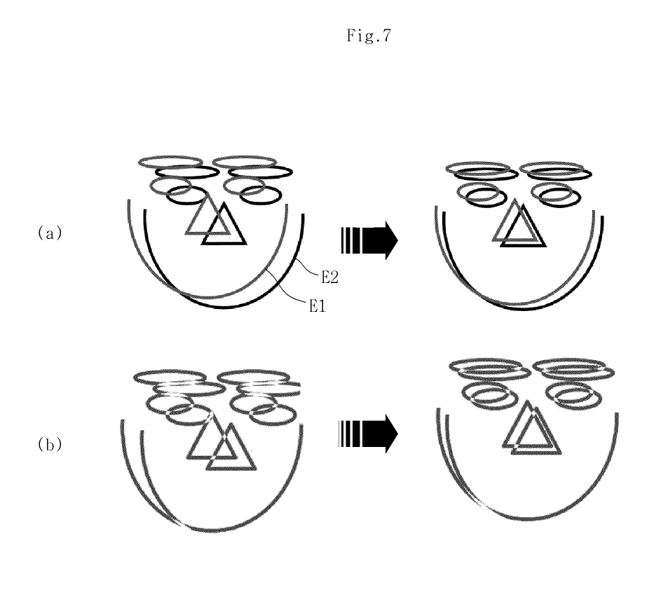

FIG. 7 shows the generation of face shape error during the face alignment process. Referring to FIG. 7, FIG. 7(a) shows the edges when the model is aligned to the input face, and ‘E1’ is an edge of the model and ‘E2’ is an edge of the input face. FIG. 7(b) represents the error in the model of FIG. 7(a).

If both the model and the input face have the same edges or if there are no edges, no error occurs. If either the model or the input face has an edge, there is an error. The shape error is calculated using the edge information obtained from the input face and the seen model. But, there is a problem that the error is not reduced exactly even if the model is correctly aligned with the corresponding face during the optimization process for the face alignment to minimize the error.

In view of the above case, assuming that the input face and the model have the same face shape, one example of the face alignment process will be described hereinafter. In FIG. 7, although the right side in the drawing did the face alignment more correctly than the left side, the red-color area in the FIG. 7(b) which represents a shape error is increased. In the right side in FIG. 7(b), red lines are closer, but it is not clear whether adjacent edges are the same or not. Errors are reduced when edges are superimposed at the edge position, and edges of the model or the input image are located at non-edge area will be error and therefore all the red-color area in the drawings will be error. Therefore, although the right side is aligned better than the left side, the size of error in the right side is similar to or more than that in the left side.

The above problem happens actually when the model is aligned with respect to the face. That is, the increase of the accuracy of the face alignment does not guarantee the reduction of the shape error and therefore, the effective optimization by the use of shape error is not ensured. To facilitate the optimization, the shape error should be reduced when the edge extracted from the model approaches the edge of the matching area of the corresponding face.

In the area having no edge in the face of the model, no edge in the image of the input face reduces the shape error and an edge in the image of the input face increases the shape error. For this, generalized shape weight is applied.

That is, depending on the degree of how the edge of the input face image is identical to the edge of the model, generalized shape weight is applied so that the edge area of the face image has the value corresponding to the edge of the model.

Further, generalized shape weight is provided in proportion to the difference of distance between the edge of the face image and the edge of the model.

Prior to the explanation of generalized shape weight, it is assumed that all face have similar face shape. Although people have different face shape, normalized face shape is extracted in the present invention and therefore a similar face shape can be obtained from different faces.

An average of edges of the face shape extracted from the seen face image is used to obtain an individual face shape in the form of the same face shape.

Since the average face edge represents the face shape roughly, error decreases as the face edge obtained from the face to be aligned approaches to the corresponding average edge. On the other hand, error increases in the area having no edges. For this, edge area is extended from the average edge of the face to the surroundings, using formula 4.

S_{intensified}(x,y)=max(Sₘₑₐₙ(x,y),G·S(x,y))

Here, Sₘₑₐₙ is an average face edge and G is a Gaussian function. The generalized shape weight w_{d} is defined from S_{intensified} as follows.

$${w}_{d} ( x , y ) = exp ( - \frac{{S}_{intensified} ( x , y )}{λ} ) \qquad formula 5$$

Here, λ is a constant and λ=100 is used in the present invention.

The error model formula 3 for the face alignment using the generalized shape weight is defined to be formula 6 as follows.

$$\sum {[ ( \overline{A} + {\sum }_{i = 1}^{m} {g}_{i} {A}_{i} ) - N ( W ( I ; t ) ) ]}^{2} + w \sum {{w}_{d} [ S ( \overline{A} + {\sum }_{i = 1}^{m} {g}_{i} {A}_{i} ) - S ( N ( W ( I ; t ) ) ) ]}^{2} \qquad formula 6$$

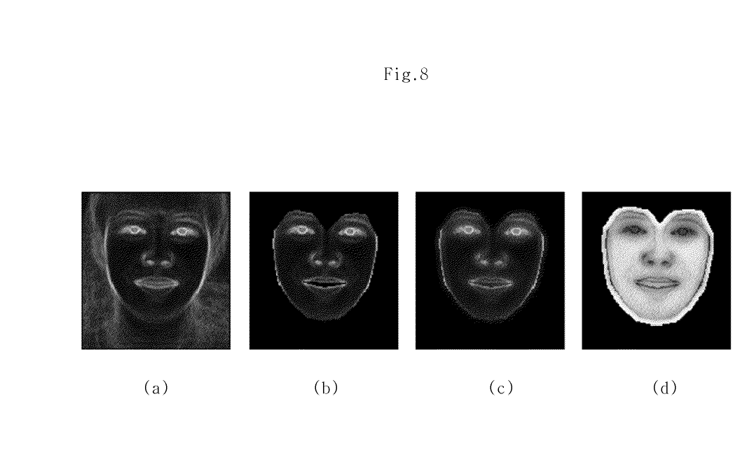

FIG. 8 represents a process of generating generalized shape weight according to the present invention. Referring to FIG. 8, FIG. 8 (b) represents that shape area is extracted from FIG. 8 (a) and FIG. 8 (c) represents that the edge area of FIG. 8 (b) is extended and FIG. 8 (d) represents that the generalized shape weight is applied to FIG. 8 (c). The generalized shape weight is high at the area where there is no edge in the seen face image and it becomes less as the edge area is approached.

The weight is applied considering the degree of how the edge of the input image is identical to the edge of the model and then the face alignment is carried out in the form of the generalized face shape.

When the face alignment is carried out using the seen face, the seen model is aligned by the conversion into the shape and texture of the seen face. However, in case of an unseen face, a model having the shape and texture most similar to the input face should be found and therefore it is difficult to carry out the face alignment. But, the use of the normalized texture of the face and the common face shape information based on the common characteristics of faces allows the face alignment for any face to be carried out efficiently.

The prior art for the face alignment uses the face shape information only and calculates the edge of the model and the edge of the input face by the difference of the textures. Therefore, although the correct match of the edges generates low error, a lot of local minima occur during the optimization. The correct face alignment cannot be expected by the use of the shape information only. However, in the present invention, the effective face alignment can be expected through the use of the average edge of the face to which the generalized shape weight is applied during the calculation of the shape error.

Hereinafter, the result of the face alignment using the face model alignment method on the unseen face according to the present invention will be described.

The accuracy of the face alignment method is evaluated by the degree of how the face model is closely aligned with predetermined feature points or land marks (ground truth) of the face. The accuracy of the face alignment of the seen model will be evaluated using the database of the face having predetermined feature points (ground truth) and will be compared with the methods of prior arts.

Three different databases are used for the evaluation. The first database is ‘IMM’ database comprising 240 face images obtained from 40 people. The database comprises, for each person, 2 front images having a null face and a smile face, 2 images which are rotated to the right and the left by about 30 degrees, a front image to which spot light is applied, and an image of random face expression. Also, 58 face feature points are provided as ground truth for each face image.

The second database is ‘BioID’ and comprises 1,521 front face images obtained from 23 people. This database provides 20 face feature points as ground truth for each face image.

The third database is ‘FGNet Talking Face Video’ and comprises continuous 5,000 frames of an interview image, and 68 face feature points are defined for each frame.

To evaluate the method of the present invention and compare it with the methods of the prior art, the evaluation is carried out by the method of the present invention as well as prior methods such as AAM, 3D AAM and multi-band AAM. The face images aligned by the feature points from the database as well as by the method of AAM, 3D AAM and multi-band AAM have different face size due to the difference of the distance. Therefore, the face size was normalized based on the distance between the both eyes and then evaluated.

Prior to the evaluation by IMM database, the database is divided into two groups each of which has 20 people. In the first group, 3D information of the face is reconstructed from the two images which are rotated to the right and the left by about 30 degrees and the images are seen using two front images of a dull face and a smile face. The prior art method uses two front images in a way similar to the present invention (AAM, multi-band AAM) or the image is seen by the use of the same 3D reconfiguration information (3D AAM).

There are two ways of the evaluation of the methods. Firstly, the face alignment was evaluated for the seen group of 20 people with respect to a spot-light face and a face of random expression which are not included in the seen face images. Secondly, the accuracy of the face alignment was calculated for the group of the unseen face of 20 people.

The following Table 1 shows the results of the evaluation for the methods. The face alignment according to the present invention has the lowest error. That is, the method of the present invention yields the most correct face alignment.

TABLE 1

| | Group of seen face | | Group of unseen face | | |
|---|---|---|---|---|---|
| Method | | face of random | | | face of random |
| [symbol] | spot-light face | expression | front face | spot-light face | expression |
| AAM | 7.64 | 9.37 | 6.40 | 9.78 | 10.16 |
| 3D AAM | 7.95 | 8.44 | 6.22 | 10.02 | 8.69 |
| Multi-band AAM | 9.15 | 8.97 | 7.00 | 10.00 | 13.26 |
| The present | 5.96 | 5.53 | 6.02 | 6.76 | 8.19 |
| invention | | | | | |

For the evaluation of the accuracy of the face alignment of the unseen face, in the second database, 40 face images of IMM database were seen for each method and then the accuracy of the corresponding database was evaluated. Meanwhile, BioID provides face features in a way similar to IMM database, but it provides face features of different locations as ground truth.

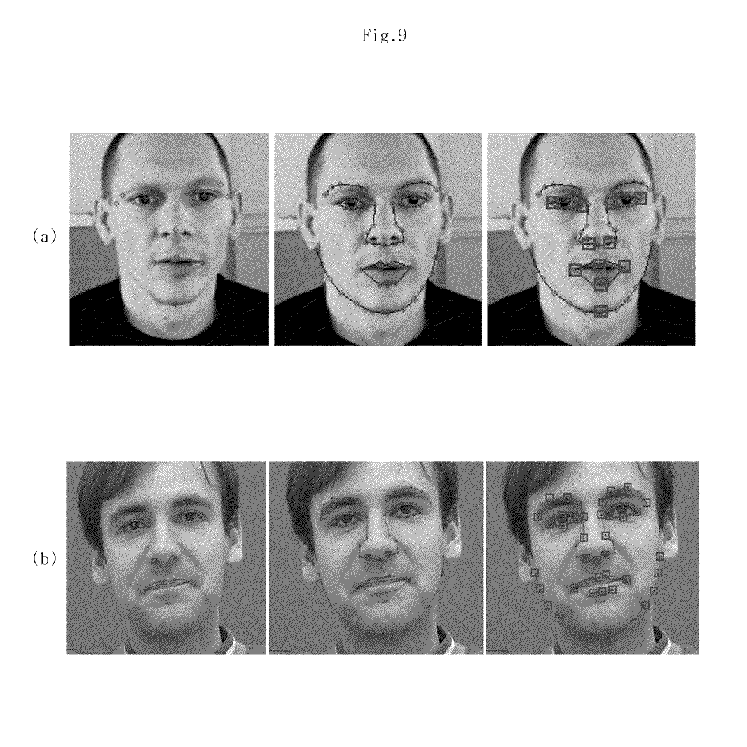

FIG. 9 shows an example of applying features of the face to the prior art for the evaluation of the present invention. Referring to FIG. 9, to facilitate the comparison of feature points of the face at similar locations in the two databases, errors are determined at the main locations such as chin, nose, mouth, eye, etc.

The Table 2 represents the result of the accuracy of BioID images for each method and the face alignment method of the present invention provides the best face alignment.

TABLE 2

| Method | Error (×10⁻²) |
|---|---|
| AAM | 12.59 |
| 3D AAM | 17.20 |
| Multi-band AAM | 14.05 |
| The present invention | 9.21 |

Also, the evaluation of FGNet Talking Face Video is carried out after each method was seen by means of IMM database. Since ground truth is provided differently, errors for similar feature points of the face were calculated in a way similar to FIG. 9 (b).

The Table 3 shows the comparison of errors for each method. Since FGNet Talking Face Video is an interview video for an individual, the object in the video does not move abruptly and thus there is no significant error. Therefore, the location of the prior frame is used for the initial location for the face alignment. In each frame, the method of the present invention and the method of 3D AAM perform the face alignment with the lowest error.

TABLE 3

| Method | Error (×10⁻²) |
|---|---|
| AAM | 6.53 |
| 3D AAM | 6.41 |
| Multi-band AAM | 24.77 |
| The present invention | 6.42 |

From the above result, the face model alignment method of the present invention provides the face alignment efficiently.

It is intended that the foregoing description has described only a few of the many possible implementations of the present invention, and that variations or modifications of the embodiments apparent to those skilled in the art are embraced within the scope and spirit of the invention. The scope of the invention is determined by the claims and their equivalents.

With a network of sensing devices linked to a central building visualization and/or control device, it will be possible to build an accurate picture of energy usage/wastage, by building one or more of a heat map, an occupancy map and a window map of a building, each of which may be used in isolation or in combination to build an effective picture of energy usage/wastage. This information may be used to balance a building and to ensure an efficient use of energy. It may further be used to ensure that buildings continue to operate to their maximum efficiency. Either manual or automatic localized heating control may be implemented in accordance with the information obtained using the sensing devices. The building visualization and/or control device may be used to control further systems or apparatuses, as will be readily appreciated by those skilled in the art.

The sensing device detailed above and a system incorporating a plurality of the sensing devices provides a powerful tool for balancing buildings and maximizing efficiency.

1. A method of face model alignment on an unseen face comprising steps:
inputting a face image;
warping said face image into a standard shaped face based on a model seen by an active appearance model so as to form a warped image;
normalizing said warped image by removing a texture change of said warped image so as to form a normalized image;
extracting a face texture from said normalized image;
calculating error areas by comparing face texture with said model; and
aligning edges of said face texture with edges of said model while reducing difference of said error areas.

2. The method according to claim 1, wherein the step of calculating error area comprises:
calculating a texture error as a difference of a texture of said model and said face texture;
calculating a shape error as a difference of edges obtained from said texture of said model and edges of said face texture; and
calculating error areas by summing said texture error and said shape error.

3. The method according to claim 2, wherein said shape error is calculated at an extended area comprising pixels located outside of an edge corresponding to a boundary of a face area.

4. The method according to claim 3, wherein the step aligning edges comprises:
applying a generalized shape weight such that edge area of said face texture corresponds to an edge of said model depending on a degree of how an edge of said face texture is identical to an edge of said model.

5. The method according to claim 4, wherein said generalized shape weight is provided in proportion to distance difference between said edge of said face texture and said edge of said model.
